(19) United States
(12) Patent Application Publication
(10) Pub. No.: US 2020/0212381 A1
(43) Pub. Date: Jul. 2, 2020

(54) METHOD AND TOOL FOR COMBING AND LOCATING FLEXIBLE CELL TABS DURING A BATTERY MANUFACTURING PROCESS

(71) Applicant: GM Global Technology Operations LLC, Detroit, MI (US)

(72) Inventors: Robert H. Dietze, Brighton, MI (US); Christopher Brady, Madison Heights, MI (US)

(73) Assignee: GM Global Technology Operations LLC, Detroit, MI (US)

(21) Appl. No.: 16/232,584

(22) Filed: Dec. 26, 2018

(51) Int. Cl. H01M 2/10; H01M 2/20; H01M 2/02

(52) U.S. Cl. CPC H01M 2/1016; H01M 2/30; H01M 2/02; H01M 2/202

(57) ABSTRACT

A method for assembling a battery section having an interconnect board (ICB) and multiple parallel battery cell tab sets arranged in a column includes positioning the battery section adjacent and parallel to an elongated guide rail. The method includes engaging a comb assembly with the guide rail, with the comb assembly having comb teeth extending orthogonally from a base. The comb assembly is translated along the guide rail toward the column, while the comb assembly remains engaged with the rail, until the base is adjacent to the column. Thereafter, each cell tab set is received between comb teeth, such that the cell tab sets are separated from, and aligned with respect to, each other. The ICB is decked to the battery section, and the comb assembly is translated along the guide rail away from the column after decking the ICB.

### INTRODUCTION

Electrochemical batteries are used as high-energy power supplies in a wide variety of electrical systems. In an exemplary construction, a battery pack may be constructed from one or more battery sections, with each battery section having stacks of interconnected battery cells. Internal to the battery cells, a thin layer of insulating material, such as polyethylene and/or polypropylene film, may be disposed between oppositely-charged electrode foils, i.e., anode and cathode foils. The electrode foils and insulating material are enclosed within a sealed outer pouch containing an electrolyte material. The anode and cathode foils are coated with lithium oxide, graphite, or another application-suitable active material. Cell tabs, which are electrically connected to the electrode foils, protrude a short distance from an outer perimeter edge of the pouch. In a task referred to as “decking”, a cell-sense interconnect board (ICB) is oriented and seated with respect to the battery section and its constituent cell tabs. The exposed cell tabs are then electrically interconnected to conductive bus bars or weld caps of the ICB.

### SUMMARY

An assembly tool is described herein that is specially configured for use in combing and locating the above-noted exposed cell tabs within a battery section. The cell tabs are constructed of metal foil, and thus are vulnerable to damage during assembly of the battery section. The assembly tool assists in locating and properly orientating cell tabs in a manner that helps reduce the risk of such damage. Battery sections potentially benefitting from use of the disclosed assembly tool include one or more cell stacks with exposed cell tabs arranged parallel in a column, with one column per cell stack, and with the various cell tabs of a given cell stack parallel to one another. Therefore, multiple parallel columns are present on a given outer surface of the battery section. Such a configuration allows the assembly tool to be used from within the footprint of the battery section, which in turn has the various advantages set forth herein.

The cell tabs that are combed and located using the present assembly tool may have a thickness of about 5 millimeters (mm) or less, and may also be separated from each other by similar distances, e.g., 3-5 mm. As a result, the cell tabs may be prone to fracturing when twisted too far or inadvertently bumped during alignment of the cell tabs prior to and during an ICB decking process. The ICB and its associated bus bars or weld caps are conductively joined to the exposed cell tabs which, after a successful decking operation, should protrude evenly and accessibly through an upper surface of the ICB.

The battery cells may also be vulnerable to errant molten droplets of weld spatter during laser welding or other high-temperature welding processes used to fuse the cell tabs together. Certain embodiments of the battery section may therefore include a thin isolative shield that is interposed between the ICB and the battery cells, with the isolative shield forming a physical barrier to such weld spatter. However, as isolative shields of certain designs require the insertion of the individual cell tabs through narrow, interference-fit through-slots in the isolative shield, use of isolative shields also increases the risk of cell tab damage. The present assembly tool and corresponding method of use are intended to facilitate assembly of battery sections using such an isolative shield, as well as battery sections lacking such isolative shields.

In an example embodiment, a method for assembling a battery section having an ICB and multiple parallel battery cell tab sets arranged in a column includes positioning the battery section adjacent and parallel to an elongated guide rail having a longitudinal axis. The method also includes engaging a comb assembly of the disclosed cell combing and location tool with the elongated guide rail, with the comb assembly having comb teeth extending orthogonally from a comb base. Additionally, the method in this embodiment includes translating the comb assembly along the guide rail toward the column, while the comb assembly remains engaged with the guide rail, until the comb base is immediately adjacent to the column. Thereafter, the battery cell tab sets are received between a respective pair of the comb teeth, such that the battery cell tab sets are separated from and aligned with respect to each other. The ICB is then decked to the battery section, whereupon the method includes translating the comb assembly along the guide rail away from the column.

The comb assembly includes a locating block defining a groove. Engaging the tool with the guide rail includes inserting the guide rail into the groove.

The method may include electrically connecting the ICB to the multiple cell tab sets.

In some embodiments, the guide rail includes fixed stops located at predetermined positions of the guide rail, with the method including using the fixed stops to prevent translation of the comb assembly beyond the predetermined positions. The fixed stops may be configured as bosses or posts extending orthogonally from the guide rail.

The battery section may include an optional isolative shield adjacent to the ICB, with the shield having transverse shield ribs each defining a respective through-slot. The method may include urging the cell tabs through the respective through-slots of the isolative shield using a manual press. The manual press may include a press handle and a corrugated surface defining transverse press ribs separated by lateral gaps. Each of the lateral gaps receives therein a respective one of the transverse shield ribs of the isolative shield and the cell tabs extending therethrough.

Also disclosed herein is a tool for combing and locating battery cell tab sets of a battery section having an ICB, with respective cells tabs of the battery cell tab sets arranged in a column. The tool includes a comb base, a plurality of comb teeth extending orthogonally from the comb base, and a locating block. The locating block is connected to the comb base and define a groove. The groove is configured to receive therein an elongated guide rail, such that the comb base, comb teeth, and locating block translate along the guide rail along a length of the battery section and toward the column. The comb teeth are configured such that a respective one of the cell tab sets fits between a respective pair of the comb teeth, and such that the cell tab sets are separated from and aligned with respect to each other via the tool prior to decking the ICB to the battery section.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is a schematic perspective exploded view illustration of an example battery section assembled with the assistance of a battery cell combing and locating assembly tool, with the assembly tool constructed as set forth below.

FIG. 2 is a schematic plan view illustration of a comb assembly usable as part of the assembly tool shown in FIG. 1.

FIG. 3 is a schematic perspective view illustration of a locating block portion of the assembly tool depicted in FIG. 2.

FIG. 4 is a schematic perspective view illustration of the example assembly tool of FIGS. 2 and 3 when used in assembling the example battery section of FIG. 1.

FIG. 5 is a schematic perspective view illustration of a set of comb teeth of the present assembly tool in the process of engaging exposed battery cell tabs.

FIG. 6 is a schematic perspective view illustration of an optional isolative shield positioned with respect to the assembly tool of FIGS. 2 and 3.

FIGS. 7 and 8 are respective side and bottom perspective view illustrations of an optional press usable as part of, or in conjunction with, the example assembly tool described herein.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

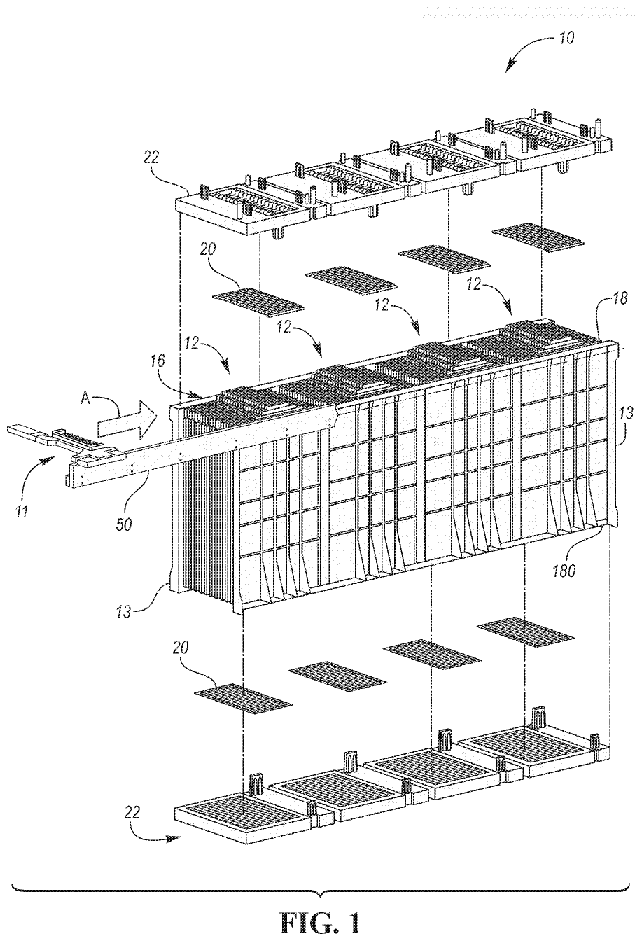

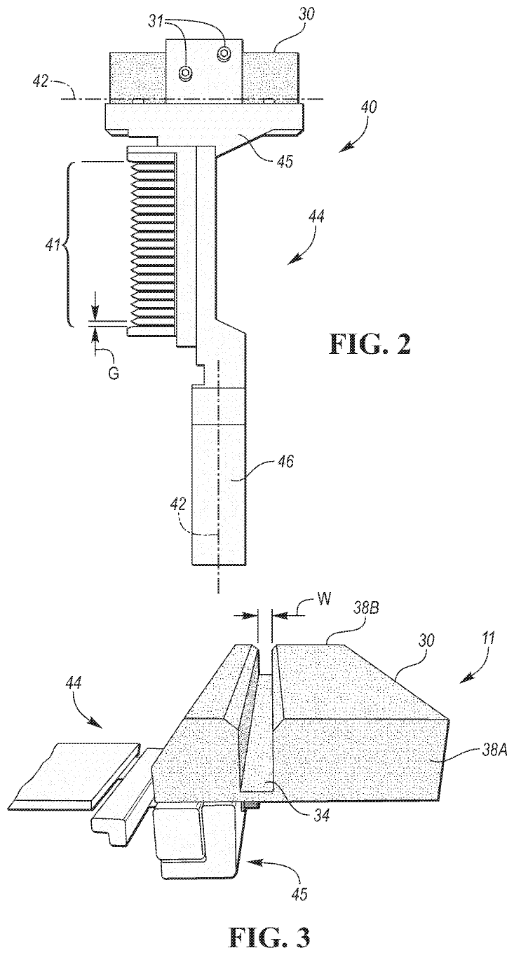

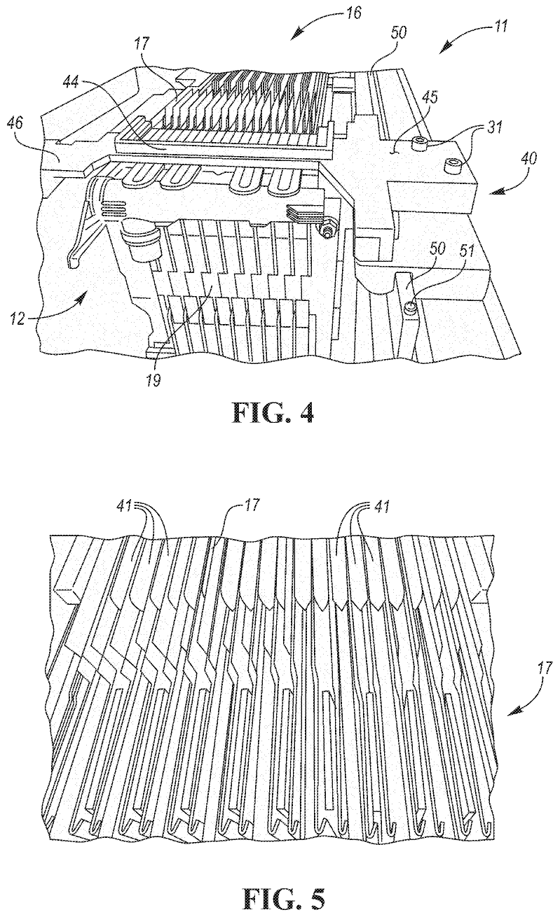

Referring to the drawings, wherein like reference numerals are used to identify like or identical components in the various views, FIG. 1 schematically illustrates an example battery section 10 constructed of one or more interconnected cell stacks 12. Each cell stack 12 includes a plurality of battery cells 16. Each battery cell 16 has corresponding set of cell tabs 17 (see FIG. 4), with the cell tabs 17 constructed of metal foil, e.g., rectangular pieces of copper or aluminum. Assembly of the battery section 10 is facilitated by a battery cell combing and locating tool 11, which is configured as described below with reference to FIGS. 2-8. Use of the locating tool 11 to comb and locate the individual cell tabs 17 prior to and during the above-noted decking process is intended to minimize the risk of an electrical short due to inadvertent damage to/misalignment of the exposed cell tabs 17 during various stages of assembly of the battery section 10.

The cells stacks 12 of FIG. 1 are positioned adjacent to protective side plates 13, e.g., plastic or other lightweight and structurally rigid walls together forming a protective and structurally supportive outer housing. While four identically-configured cell stacks 12 are shown in FIG. 1, the actual number of cell stacks 12 used in a given battery section 10, and the actual number of battery sections 10 used in the overall construction of a battery pack, may vary with the intended application. Within the interior of the cell stacks 12, battery cells 16 may be embodied as polymer-coated foil pouch-type electrochemical cells of the type described above. As such, each battery cell 16 includes internal positive and negative electrode foils (not shown) respectively terminating in a charge-specific one of the cell tabs 17. Longitudinal axes of the individual cell tabs 17, and thus the cell tabs 17 themselves, are arranged parallel to one another and, within a given one of the cell stacks 12, are also aligned in a column as shown.

The cell tabs 17 protrude orthogonally from diametrically-opposite outer surfaces 18 and 180 of the cell stack 12/battery section 10. In the illustrated configuration, the cell tabs 17 protruding through a given outer surface 18 or 180 are arranged with alternating positive and negative polarities. That is, adjacent cell tabs 17 of two adjacent battery cells 16 have opposite charges, such that a negative cell tab 17 (anode tab) of a given battery cell 16 is positioned immediately adjacent to a positive cell tab 17 (cathode tab) of another battery cell 16, and so forth. Although not visible from the perspective of FIG. 1, an identical set of cell tabs 17 extends from the outer surface 180, and so assembly of the battery section 10 may require rotation of the battery section 10 to perform a similar assembly operation on both of the outer surfaces 18 and 180. For illustrative simplicity, operations will be described below with reference to the outer surface 18, which is to be understood as also applying to the outer surface 180.

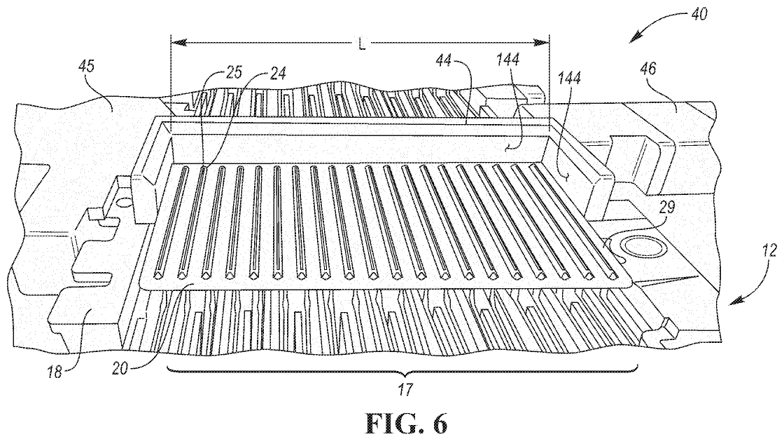

For each cell stack 12 that is used in the example battery section 10 of FIG. 1, an optional isolative shield 20 may be disposed adjacent to the outer surfaces 18 or 180, respectively, with the structure and function of the isolative shield 20 described in further detail below with particular reference to FIG. 6. When the isolative shield 20 is used as part of the battery section 10, the individual cell tabs 17 are ultimately inserted through the isolative shield 20. Whether or not the optional isolative shields 20 are used in the overall construction of the battery section 10, a cell sense board/interconnect board (ICB) 22 is situated on or adjacent to the outer surfaces 18 or 180, respectively. When decked, the cell tabs 17 will protrude through the ICBs 22. The now-protruding cell tabs 17 are electrically connected to the ICBs 22 via conductive bus bars or weld caps (not shown) of the ICB 22, with such bus bars or weld caps situated on or proximate the outer surfaces 18 and 180.

Although omitted from the Figures for illustrative simplicity, a battery controller (not shown) may be used in conjunction with the battery section 10 once the battery section 10 is in operation. Such a battery controller would be electrically connected to the ICBs 22 and used to regulate operation of the battery pack. As such, the ICBs 22 may be embodied as multi-purpose electrical sensing boards and used to measure individual cell voltages and/or currents, temperatures, and possibly other control parameters for each of the battery cells 16, and to output control signals to the battery section 10 to control, e.g., power flow to or from the battery section 10.

The locating tool 11 shown in FIG. 1 is intended to be used as part of a combing and locating operation that facilitates a subsequent decking process of the ICBs 22. In general terms, the present method proceeds by positioning the battery section 10 adjacent and parallel to an elongated guide rail 50 of the locating tool 11, a portion of which is shown in FIG. 1 for illustrative clarity and simplicity. The guide rail 50 may be embodied as an elongated rectangular beam as shown and constructed of aluminum or another sufficiently rigid material. The battery section 10 is positioned immediately adjacent to the guide rail 50, with the battery section 10 and the guide rail 50 being parallel to each other. The guide rail 50 thus serves as a fixed linear reference axis for indexing motion and placement of the locating tool 11 during the combing and location process described herein.

The locating tool 11 shown in FIG. 1 is configured to engage the guide rail 50 and thereafter translate or slide along the guide rail 50 toward the cell tabs 17 of a given cell stack 12, with translation indicated by arrow A. Translation of the locating tool 11 along the guide rail 50 occurs until the locating tool 11 is adjacent to a particular column of cell tabs 17 to be combed and located. From the perspective of FIG. 1, for instance, the locating tool 11 may be initially placed to the left of the battery cells 17 of the cell stack 12 located to a viewer's extreme right in FIG. 1, and thereafter used to comb and position the exposed cell tabs 17 of the subject cell stack 12 as set forth below. The process is repeated as the locating tool 11 is moved from right to left in FIG. 1, such that the combing and location process occurs sequentially at each of the cell stacks 12 from within a footprint of the battery section 10.

Each set of cell tabs 17, whether such a set encompasses a single cell tab 17 or multiple cells tabs 17, is combed and located by the locating tool 11, such that the cell tabs 17 or sets thereof are gently separated from each other and aligned in preparation for subsequent decking. Afterward, the ICBs 22 are decked to the battery section 10, possibly with the assistance of a vacuum tool (not shown) that may interface with the described locating tool 11. The locating tool 11 is then translated to the next adjacent column of cell tabs 17, with the combing, locating, and decking processes repeated until the various ICBs 22 are properly decked. The battery section 10 is then assembled via welding of the ICBs 22 to the exposed cell tabs 17 using the above-noted conductive bus bars or weld caps (not shown), as will be appreciated by one of ordinary skill in the art.

Referring to FIGS. 2 and 3, the locating tool 11 depicted in FIG. 1 includes a comb assembly 40 constructed of a suitable dielectric material, such as molded plastic, glass-filled nylon, fiberglass, or rubber. The comb assembly 40 has an elongated comb base 44 that defines a spaced plurality of comb teeth 41, with the individual comb teeth 41 arranged orthogonally with respect to a longitudinal axis 42 of the comb base 44. The comb base 44 may terminate in a comb handle 46, which in turn is configured to be comfortably grasped by an operator in the course of performing the above-noted combing and locating tasks. For instance, the comb handle 46 may include a rubberized coating, textured surface pattern, or other features for improving the overall comfort and security of the operators grip on the comb handle 46.

The comb assembly 40 of FIG. 2 also includes a locating block 30. The locating block 30 is connected to the comb base 44 at an opposite end of the comb assembly 40 relative to the comb handle 46. For instance, the comb base 44 may terminate in a bridge piece 45, with the bridge piece 45 integrally formed with the comb base 44 or connected thereto. Fasteners 31 may be used to connect the locating block 30 to the bridge piece 45, and/or a strong adhesive material such as epoxy cement may be used to secure the locating block 30 in the indicated position. In other embodiments, the locating block 30 may be integrally formed with the comb base 44.

The locating block 30 defines a groove 34, which is shown in FIG. 3 as an elongated slot extending between distal ends 38A and 38B of the locating block 30. The grove 34 has a width (W) that is slightly larger than that of the guide rail 50 of FIG. 1, e.g., 1-2 mm. The groove 34 also has an axis 42 (see FIG. 3) that, in the illustrated embodiment, is orthogonal or normal to the longitudinal axis 42 of the comb base 44. The groove 34 is therefore configured to receive the guide rail 50 within the width (W) and enable the comb assembly 40 to freely translate along the guide rail 50.

In operation, the comb assembly 40 of FIGS. 2 and 3 receives the cell tabs 17 of a given one of the cell stacks 12 shown in FIG. 1. That is, a set of the cell tabs 17, which may include a single cell tab 17 or multiple cell tabs 17 depending on the application, is received between a respective adjacent pair of the comb teeth 41 of FIG. 3. The individual comb teeth 41 are separated from each other by a small gap (G), with the size of the gap (G) corresponding to the number of cell tabs 17 to be received between the comb teeth 41. For instance, the gap (G) may be sized such that two cell tabs 17, cannot fit in the gap (G) between adjacent comb teeth 41. Multiple sets of the cell tabs 17 are thus separated from each other and aligned prior to decking the ICB 22 to the battery section 10.

FIGS. 4 and 5 shows the combing and locating tool 11, in this particular embodiment the comb assembly 40 and the guide rail 50 of the locating tool 11, as the locating tool 11 appears in use with a representative cell stack 12. FIG. 4 depicts the comb assembly 40 when fully engaged with the cell tabs 17, while FIG. 5 provides a close-up view of the interspacing of the cell tabs 17 and comb teeth 41. In order to successfully deck the ICBs 22 of FIG. 1, the cell tabs 17 are nominally spaced, for instance about 3-5 mm apart. The gap (G) between comb teeth 41 as shown in FIG. 2 is therefore sized to provide a snug interference fit with the cell tabs 17 which, when the comb assembly 40 of FIGS. 4 and 5 is eventually extracted, helps ensure such nominal spacing.

In order to seat the ICBs 22 on the cell stacks 12 without bending or crushing the protruding cell tabs 17, the comb assembly 40 is carefully translated along the guide rail 50 toward and into gentle contact with the cell tabs 17. The perspective of FIG. 4 shows an end of the battery section 10, and thus side walls 19 of the battery section 10 are visible. Example sets of the cell tabs 17 are shown in FIG. 5 as interspaced between the various comb teeth 41. A typical configuration of the cell tabs 17 surrounds the cell tabs 17 by thicker layer of material at an interface along the outer surface 18 or 180 of the cell stack 12, with such surfaces 18 and 180 shown in FIG. 1. Thus, contact may occur between the comb assembly 40 and the material surrounding the base of the cell tabs 17. Alternatively, the guide rail 50 may include fixed stops 51 in the form of small radial projections extending orthogonally from the guide rail 50, e.g., posts or bosses. The location of the example fixed stop 51 of FIG. 4 is illustrative, with the actual location being at a position coinciding with the desired extent of reception of the cell tabs 17 between the comb teeth 41. Such fixed stops 51 may be formed or connected to the guide rail 50 at predetermined positions along the length of the guide rail to block movement of the comb assembly 40 into direct contact with the fragile edges of the cell tabs 17. In this manner, the cell tabs 17 may be prevented from “bottoming out” against the comb base 44 of the comb assembly 40 between the comb teeth 41, without adversely affecting the combing and locating performance of the locating tool 11.

FIG. 6 illustrates an embodiment of the battery section 10 of FIG. 1 in which the optional isolative shield 20 is used with a corresponding cell stack 12. The comb assembly 40 is depicted as engaged with the cell tabs 17, with the isolative shield 20 positioned adjacent to and on top of the comb assembly 40. The isolative shield 20 includes a corrugated body 29 constructed of a thin, generally flat or planar piece of temperature-resistant material. For instance, the isolative shield 20 may be thermoformed, or it may be constructed via compression or injection molding, using an application-suitable suitable thermoplastic material. The isolative shield 20 has a thickness sufficient for withstanding errant droplets of molten copper, aluminum, or other metals used in the construction of the cell tabs 17. Weld spatter droplets are typically on the order of about 0.05-0.1 mm, and therefore a functionally sufficient thickness of the isolative shield 20 is less than 1 mm in some embodiments.

The isolative shield 20 defines a plurality of transverse shield ribs 24, i.e., arranged normally or orthogonally with respect to a longitudinal axis of the isolative shield, each having a respective through-slot 25. In turn, the through-slots 25 have a corresponding slot width that is slightly smaller than a width of the cell tabs 17 of FIGS. 1, 4, and 5, such that an interference fit is provided between the transverse shield ribs 24 and the cell tabs 17 once the latter have been inserted into the through-slots 25. That is, the cell tabs 17 should pass through the through-slots 25 with minimal contact and resultant frictional forces after insertion. An example thickness of the cell tabs 17 is in the range of about 0.2 mm-0.4 mm, and therefore a suitable slot width is smaller than the thickness of the cell tabs 17 by an amount sufficient for providing the above-noted interference fit.

Visible from the perspective of FIG. 6 are the comb handle 46, comb base 44, and bridge piece 45. The comb base 44 may define orthogonally-arranged side walls 144, with the longer of the side walls 144 having a length (L). The isolative shield 20 is slightly shorter than length (L) and the side walls 144 are raised relative to the bridge piece 45 and comb handle 46, such that the isolative shield 20, when received by the comb assembly 40, is partially surrounded by the side walls 144. The comb assembly 40 is thus used to align the isolative shield 20 prior to installation of the isolative shield to the exposed cell tabs 17.

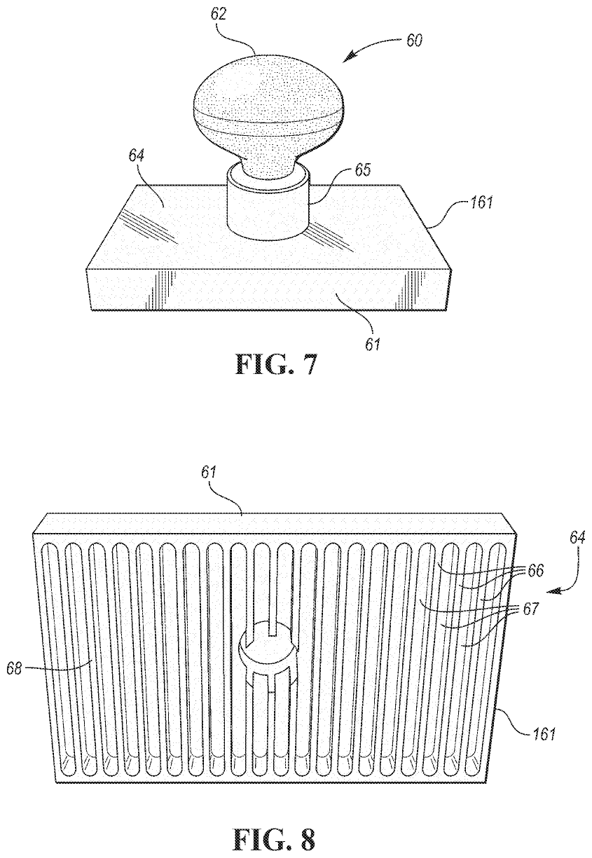

Referring to FIG. 7, the above-described locating tool 11 may include an optional press 60. The press 60 includes a press body 64 with side walls 61 and 161. A knob 62 is mounted to the press body 64, with the knob 62 threaded, bonded, or otherwise joined to a pedestal 65. The pedestal 65, e.g., a cylindrical pedestal as shown, may be co-molded with the press body 64. During assembly of the example battery segment 10 of FIG. 1, an operator may grasp the knob 62 and move the press 60 into alignment with the isolative shield 20 of FIG. 6, which itself is aligned with the two side walls 144 of the comb assembly 40. Once aligned, the operator may apply gentle downward pressure on the isolative shield 20 to urge the cell tabs 17 into the corresponding through-slots 25.

To facilitate the above-described process, the press body 64 may define a corrugated surface 68 as shown in FIG. 8. The corrugated surface 68 includes a plurality of transverse press ribs 66, i.e., extending width-wise across the press body 64. Such press ribs 66 are separated by lateral cell gaps 67. Once the press 60 is properly seated on the comb assembly 40 and isolative shield 20 of FIG. 6, the gentle downward pressure applied to the press 60 guides the exposed cell tabs 17 into the through-slots 25 of the isolation shield 20. The cell tabs 17 ultimately enter the lateral cell gaps 67 of the corrugated surface 68, with the various cell gaps 67 configured, without contacting the cell tabs 17, to receive the transverse shield ribs 24 of FIG. 6 and the cell tabs 17 protruding therethrough. Use of the optional press 60 of FIGS. 7 and 8 thus helps isolate the cell tabs 17 from each other while securely seating the isolative shield 20 into its final pre-decking position.

As will be appreciated, the structure described above enables a method for assembling the battery section 10 of FIG. 1. Such a method may include engaging the comb assembly 40 (FIG. 2) of the locating tool 11 with the elongated guide rail 50, e.g., by inserting the guide rail 50 into the groove 34 of FIG. 5. The locating tool 11 is then translated along the guide rail 50 until the exposed cell tabs 17 in a given column are received and positioned between the comb teeth 41. Due to the engagement of the locating block 30 (FIGS. 2 and 3) with the guide rail 50, the locating tool 11 cannot rotate about its Z-axis/height dimension, and thus there is minimal risk of an inadvertent electrical short from twist-induced forces and damage from such twisting. If the isolative shield 20 of FIG. 6 is used, the isolative shield 20 would be installed at this point of the method, possibly with the assistance of the optional press 60 of FIGS. 6 and 7. While the locating tool 11 remains in place, the ICB 22 of FIG. 1 is decked on the positioned cell tabs 17. The locating tool 11 is thereafter removed from the ICB 22 to enable the ICB 22 to be fully seated. The method may include electrically connecting the ICB 22 to the cell tabs 17 or sets thereof, e.g., via laser or ultrasonic welding. This process is repeated until the battery section 10 is complete.

Those of ordinary skill in the art will appreciate, in view of the foregoing disclosure, that the locating tool 11 may be used to prevent cell tabs 17 from being misaligned during the decking process, and to thereby avoid a short. As shorts may occur when cell tabs 17 come into contact with each other, and as ICB decking is usually a manual operation on a blind load, operator variability may lead to twisting of the comb 40 and possible electrical short conditions. Use of the guide rail 50 with the integrated guide block prevents such twisting and shorts, and thereby helps reduce operator error. Moreover, the tool assembly 11 combs the cell tabs 17 from within the battery section 10 rather than from an outside-to-inside manner, which likewise facilitates optimal results.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. A method for assembling a battery section, the battery section having an interconnect board (ICB) and multiple parallel battery cell tab sets arranged in a column, the method comprising:
positioning the battery section adjacent and parallel to an elongated guide rail having a longitudinal axis;
engaging a comb assembly of a cell combing and location tool with the elongated guide rail, wherein the comb assembly includes a plurality of comb teeth extending orthogonally from a comb base;
translating the comb assembly along the guide rail toward the column of the multiple battery cell tabs, while the comb assembly remains engaged with the guide rail, until the comb base is immediately adjacent to the column;
receiving each of the battery cell tab sets between a respective pair of the comb teeth, such that the battery cell tab sets are separated from and aligned with respect to each other;
decking the ICB to the battery section; and
translating the comb assembly along the guide rail away from the column after decking the ICB.

2. The method of claim 1, wherein the comb assembly includes a locating block defining a groove, and wherein engaging the cell combing and location tool with the elongated guide rail includes inserting the elongated guide rail into the groove.

3. The method of claim 1, further comprising: electrically connecting the ICB to the multiple cell tab sets.

4. The method of claim 1, wherein the guide rail includes fixed stops located at predetermined positions of the guide rail, further comprising: using the fixed stops to prevent translation of the comb assembly beyond the predetermined positions.

5. The method of claim 4, wherein the fixed stops are bosses or posts extending orthogonally from the guide rail.

6. The method of claim 1, wherein the battery section includes an isolative shield adjacent to the ICB and having a plurality of transverse shield ribs each defining a respective through-slot, the method further comprising: urging the cell tabs through the respective through-slots of the isolative shield using a manual press.

7. The method of claim 6, wherein the manual press includes a press handle and a corrugated surface defining transverse press ribs separated by lateral gaps, and wherein each of the lateral gaps is configured to receive therein a respective one of the transverse shield ribs of the isolative shield and the cell tabs extending therethrough.

8. A tool for combing and locating battery cell tab sets of a battery section having an interconnect board (ICB), wherein respective cells tabs of the battery cell tab sets are arranged in a column, the tool comprising:
a comb base;
a plurality of comb teeth extending orthogonally from the comb base; and
a locating block connected to the comb base and defining a groove, wherein the groove is configured to receive therein an elongated guide rail, such that the comb base, the plurality of comb teeth, and the locating block translate along the guide rail along a length of the battery section and toward the column;
wherein the plurality of comb teeth is configured such that a respective one of the cell tab sets fits between a respective pair of the comb teeth, and such that the cell tab sets are separated from and aligned with respect to each other via the tool prior to decking the ICB to the battery section.

9. The tool of claim 8, further comprising: the guide rail.

10. The tool of claim 9, wherein the guide rail is rectangular.

11. The tool of claim 10, wherein the guide rail is constructed of aluminum.

12. The tool of claim 8, wherein the comb base and comb teeth are integrally formed.

13. The tool of claim 8, further comprising: a comb handle connected to or formed integrally with the comb base.

14. The tool of claim 8, wherein the guide rail includes fixed stops located at predetermined positions of the guide rail, the fixed stops being configured to prevent translation of the tool beyond the predetermined positions.

15. The tool of claim 14, wherein the fixed stops are bosses or posts extending orthogonally from the guide rail.

16. The tool of claim 8, further comprising: a manual press having a press handle and a corrugated surface, wherein the comb base defines orthogonal walls against which the tool is configured to seat during a manual pressing operation when decking the ICB.

17. The tool of claim 16, wherein the corrugated surface defines transverse cell gaps each configured to receive at least a respective one of the cell tab sets during the manual pressing operation.

18. The tool of claim 16, wherein the battery section includes an isolative shield defining a plurality of transverse shield ribs each defining a respective through- slot, the isolative shield is located between the ICB and the cell stack, and the manual press is configured to urge the cell tabs through corresponding one of the through-slots of the isolative shield.
